(19) United States
(12) Patent Application Publication
(10) Pub. No.: US 2004/0012334 A1
(43) Pub. Date: Jan. 22, 2004

(54) Video signal processing

(76) Inventors: Robert Jan Schutten, Campbell, CA (US); Christian Hentschel, Eindhoven (NL); Abraham Karel Riemens, Eindhoven (NL); Olukayode Anthony Ojo, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/008,109

(22) Filed: Nov. 8, 2001

(30) Foreign Application Priority Data
Nov. 9, 2000 (EP) 00203951.9

(51) Int. Cl. H01J 23/34

(52) U.S. Cl. 315/1

(57) ABSTRACT

A method of filtering a video signal comprised of a luminance component (Y) and two multiplexed chrominance components (U, V), a same filter architecture being used for forming a luminance signal and a chrominance signal, wherein for both the luminance component and two multiplexed chrominance components it holds that for horizontally filtering at least two non-zero filtering coefficients are used. Preferably, the filter architecture is a low-pass filter arranged to average neighboring pixel data with a weighting coefficient chosen such that the ratio between the sum of the even coefficients and the sum of the odd coefficients is 1:1. Thus the overall weighting of the two chrominance components will be equal. Alternatively, the filter architecture is a low-pass filter with horizontal chrominance weighting coefficients of 1,0,1. This allows processing for the luminance at the same time as allowing low-pass chrominance filtering in the horizontal direction.

The present invention relates to a method of and device for filtering a video signal comprised of a luminance component (Y) and two multiplexed chrominance components (U, V). The invention also relates to a display apparatus comprising such a device.

In “Noise Reduction Filters For Dynamic Image Sequences: a review”, Brailean, J. C.; Kleihorst, R. P.; Efstratiadis, S.; Katsaggelos, A. K.; Lagendijk, R. L. Corp. Syst. Res. Lab., Motorola Inc., Schaumburg, Ill., USA, Proceedings of the IEEE, pp. 1272-1292 September 1995; Vol. 83; Issue: 9; ISSN: 0018-9219, Brailean et al. present an overview of noise reduction filters for dynamic image sequences. At page 1282, expression 29, a temporal recursive filter is proposed. In the text following this expression, it is explained that the value of α(i,j,k) is of prime importance to avoid visual artefacts. Several methods to determine α are proposed and discussed.

The present invention may be applied to determine such α values. For this purpose, the present invention leads both to video signal of high subjective quality while the implementation cost is relatively small. Thus, the present invention aims to provide an improved and simplified circuit. More applications exist, which require a similar adaptivity to the local motion in the scene. The invention is defined in the independent claims. Advantageous embodiments are defined in the dependent claims.

According to one embodiment of the present invention there is provided a circuit for processing a video signal comprised of a luminance component and two multiplexed chrominance components, wherein the circuit comprises a processing filter for forming a luminance or a chrominance control signal, and is characterised by a single filter input arranged to receive the video signal; wherein the filter is a low-pass filter arranged to average neighboring pixel data with a weighting coefficient chosen such that the ratio between the sum of the even coefficients and the sum of the odd coefficients is 1:1. Thus the overall weighting of the two chrominance components will be equal.

For example for a two tap horizontal filter the weighting coefficient may be chosen as 1,1; for a three tap filter the weighting coefficient may be 1,2,1; for a four tap filter the coefficients could be 1,3,3,1 and for a five tap filter 1,3,4,3,1. Many other combinations are possible.

According to a preferred embodiment the circuit also comprises an absolute value former and may comprise a look-up-table.

The coefficients of the low-pass filter are in general not critical for the luminance component but do influence the weighting of the two components of the multiplexed chrominance signal. In more general term, it comprises a non-linear function.

The luminance and the chrominance signals are generally time multiplexed.

The circuit of the invention provides for exactly identical paths to be used for the luminance and the chrominance components of a video signal, and is thus efficient in its use of hardware. It also reduces noise from the incoming signal and achieves a smoother and more reliable combined control signal.

A second embodiment of the invention provides a pre-filter circuit for a video signal comprising a luminance signal and a multiplexed chrominance signal. Such a filter may be applied to reduce noise or to measure local image statistics for adaptive control of image improvement algorithms. The filter is designed such, that it is able to process a luminance or a multiplexed chrominance signal, using the same access pattern. To handle the same access pattern, specific control means are available to disable a subset of the coefficients. Herein, the subset consists of every 2^{nd} coefficient in the horizontal direction, chosen in such a way that the maximum number of pixels is active. For the luminance component of the video signal, all filter coefficients are active. For the multiplexed chrominance component of the video signal, only the subset is active. To achieve maximum noise reduction, all active pixels are filtered with equal weight. As an example, for or a horizontal 3 tap filter the luminance is filtered using coefficients 1,1,1 while chrominance is processed using 1,0,1. Traditional methods would result in a 0,1,0 filter for chrominance (which does not do any filtering), or a 1,0,1,0,1 filter (which needs a different data access pattern).

The pre-filter circuit achieves better noise reduction when processing chrominance data in the horizontal dimension yet is of a relatively simple design which is cost-effective to manufacture.

The video processing circuit of the first embodiment may comprise the circuit of the second embodiment as a pre-filter to reduce noise before post-processing.

For a better understanding of the present invention and to show how the same may be carried into effect, reference will now be made to the accompanying drawings in which:

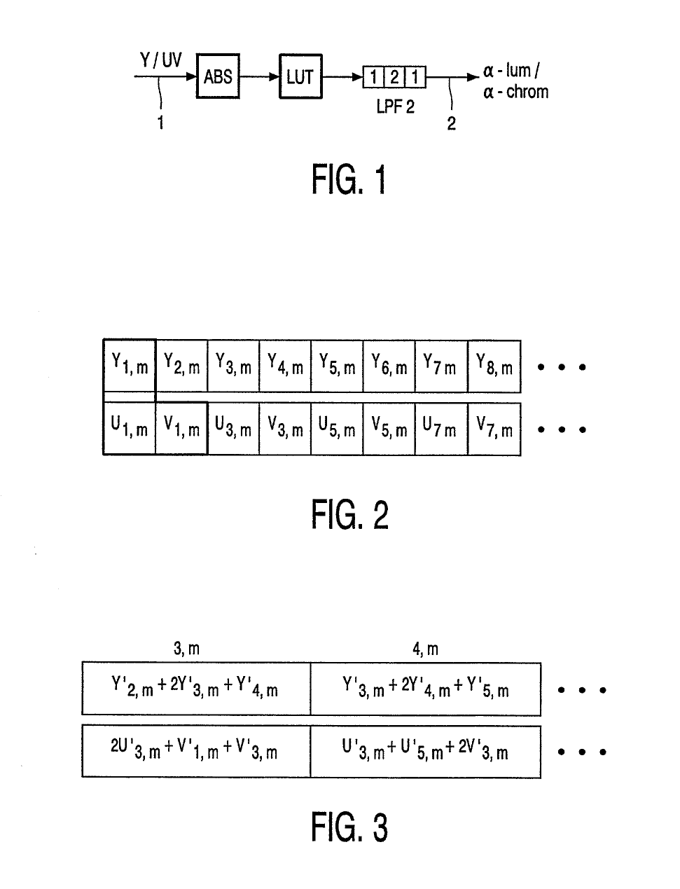

FIG. 1 is a schematic block diagram of a circuit according to a first embodiment of the present invention;

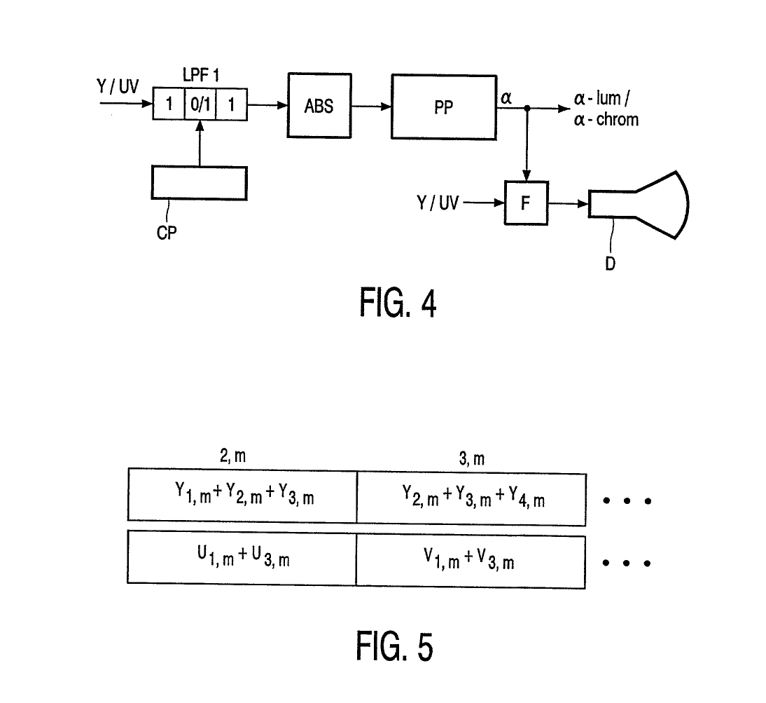

FIG. 2 schematically illustrates the time-multiplexed components of a video signal for processing in the circuit of FIG. 1 or the circuit of FIG. 4;

FIG. 3 schematically illustrates the contributions from neighboring pixels for the components of the video signal for processing in the circuit of FIG. 1;

FIG. 4 is a block circuit diagram showing a pre-filter according to a second embodiment of the invention; and

FIG. 5 is a diagrammatic illustration of the contribution from neighboring pixels for the components of the video signal for processing in the pre-filter of FIG. 4.

The circuit of FIG. 1 comprises an input 1, an absolute value former ABS, and post-processing circuitry comprising a look-up table LUT and a low-pass filter LPF2 with a control signal α provided at an output 2. A video signal is supplied to input 1 and comprises a luminance component Y and a chrominance part comprising two multiplexed chrominance components U, V (according to FIG. 2). The luminance and chrominance parts are time multiplexed. The control signal α comprises α-lum for the luminance signal Y and a combined control signal α-chrom for the two components U, V of the chrominance signal.

The low-pass filter LPF2 has the filter coefficients 1, 2, 1 in the horizontal direction. The look-up table LUT is optional and provides a monotone, non-linear function. The absolute value former ABS and the look-up table LUT effect processing on the incoming pixel data without spatial processing. The low-pass filter LPF 2 averages neighboring pixels to produce a smooth and soft fading function avoiding artifacts from hard switching. It produces the control signal α-lum for the luminescence component Y and a combined control signal α-chrom for the two chrominance components U, V.

In FIG. 2 the incoming digital video data samples Y_{n,m}, U_{n,m}, V_{n,m} are shown with a sample structure of a 4:2:2 signal as described in ITU-R-BT.601-5. FIG. 2 shows several pixels 1, 2, 3 where

Y=component of the luminance data

U=first component of the chrominance data

V=second component of the chrominance data

n=pixel number

m=line number.

The two components U, V of the chrominance of a pixel are time multiplexed and each pixel is fully defined by the three components Y, U, V. As will be seen in FIG. 2 the chrominance data comprises only every second pixel value, having typically undergone sub-sampling through another low-pass filter (not shown).

The signal represented in FIG. 2 is applied to the circuit of FIG. 1. The ABS and LUT operations transform the input signals Y_{n,m}, U_{n,m}, V_{n,m} into Y′_{n,m}, U′_{n,m} V′_{n,m} respectively. The weighted results at the output are schematically illustrated in FIG. 3.Thus a pixel at column 3 on line m is defined by the components Y_{3,m}, U_{3,m}, V_{3,m}. The averaging of filter LPF2 means that contributions are provided by neighboring pixels. The state of the signals after passing through the filter is as shown in FIG. 3. The first calculated luminance pixel at position 3,m is given by Y′_{2,m}+2*Y′_{3,m}+Y′_{4,m}. The contributory components are symmetrical about the center pixel. The chrominance pixel at position 3,m is given by V′_{1,m}+2*U′_{3,m}+V′_{3,m}. So for the U component the contributory components are also symmetrical about the center pixel, at this pixel position but not for the V component which is only delayed by one pixel. Since overall the weighting of U and V components is equal then the small matching error of V can be neglected.

In this way it can be seen that the invention provides for generating independent control signals for luminance and chrominance and assists in noise reduction. In addition, the same implementation is used for luminance and chrominance processing.

The circuit of FIG. 4 shows the pre-filter LPF1 in more detail. The pre-filter LPF1 reduces noise from the incoming signal and thus assists in achieving a smoother and more reliable control signal α-lum or α-chrom. Typically it has been an averaging filter with horizontal coefficients of 1,1,1 for the luminance, and for the chrominance 0,1,0 to prevent a mix-up of U and V from occurring. However these coefficients for the chrominance do not permit horizontal filtering, only the center pixel is passed to the output. Thus preferably LPF1 comprises the pre-filter of the second aspect of the invention with horizontal coefficients 1,0,1.

For luminance components the pre-filter would preferably be a 3-tap filter with the coefficients 1,1,1 since this is very efficient for noise reduction. In fact the unweighted noise reduction factor is 4.8 dB. However such an arrangement is limited for the chrominance signal and instead the center pixels only have previously been used for the chrominance processing. This results in coefficients 0,1,0 in the horizontal direction and no noise reduction (0 dB).

Instead, according to the present invention the adjacent 2 pixels are used for chrominance pre-processing increasing the noise reduction factor to 3 dB. This arrangement reverses the U and V components but this is not significant for this application since post-processing typically forms a common control signal for the combination of U and V components. Preferably, the filter architecture is 2-dimensional in that it has an identical second row (not shown), whereby also a vertical filtering is performed.

For switching to zero the center coefficient for chrominance, the device of FIG. 4 comprises a coefficient control CP. The low-pass filter LPF1 is optionally followed by an absolute value former ABS and a post-processing block that furnishes control signals α-lum or α-chrom. The control signals α-lum and α-chrom are used in a filter F, such as a noise-reduction filter, that receives input luminance signals Y and input chrominance signals UV, and that furnishes a display signal to a display D.

FIG. 5 shows the results of the pre-filtering illustrated in FIG. 4 for the two pixels respectively at position 2 on line m and position 3 on line m. It can be seen that the V component for pixel 3, m has its center position at 2, m and this results in a delay error of 1 pixel but this is not significant.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of filtering a video signal comprised of a luminance component and two multiplexed chrominance components, a same filter architecture being used for forming a luminance signal and a chrominance signal, wherein for both the luminance component and two multiplexed chrominance components it holds that for horizontally filtering at least two non-zero filtering coefficients are used.

2. A method as claimed in claim 1, wherein the at least two non-zero filtering coefficients for chrominance are identical to corresponding non-zero filtering coefficients for luminance.

3. A device for filtering a video signal comprised of a luminance component (Y) and two multiplexed chrominance components (UV), the device comprising a same filter architecture (LPF1, LPF2) for forming a luminance signal (α-lum) and a chrominance signal (α-chrom), wherein for both the luminance component and two multiplexed chrominance components it holds that for horizontally filtering at least two non-zero filtering coefficients are used.

4. A device as claimed in claim 3, wherein the device comprises a low-pass filter (LPF2) arranged to average horizontally neighboring pixel data with filtering coefficients chosen such that the ratio between the sum of the even filtering coefficients and the sum of the odd filtering coefficients is 1:1.

5. A device according to claim 4, wherein the filter is a two-tap horizontal filter with filtering coefficients of 1,1, a three-tap horizontal filter with filtering coefficients of 1,2,1, a four-tap horizontal filter with filtering coefficients of 1, 3, 3, 1, or a five-tap horizontal filter with filtering coefficients of 1, 3, 4, 3, 1.

6. A device according to claim 3, wherein the filter architecture also performs vertical processing.

7. A device according to claim 3, further comprising a control part (CP) arranged to selectively disable coefficients of the filter architecture such that alternate coefficients are non-zero.

8. A device according to claim 7, applied such that all filtering coefficients are non-zero for luminance and a subset is non-zero for chrominance.

9. A device according to claim 8, wherein the filter is a three-tap horizontal filter with filtering coefficients of 1,1,1 for luminance (Y) and 1,0,1 for chrominance (UV), or a five-tap horizontal filter with a weighting coefficient of 1,1,1,1,1 for luminance (Y) and 1,0,1,0,1 for chrominance (UV).

10. A device according to claim 3, further comprising a noise reduction filter (F), the luminance signal (α-lum) and the chrominance signal (α-chrom) being control signals for the noise reduction filter (F).

11. A video signal display apparatus, comprising:
the device of claim 3; and
a display (D) coupled to an output of the device of claim 3.
